(19) United States
(12) Patent Application Publication
(10) Pub. No.: US 2008/0306761 A1
(43) Pub. Date: Dec. 11, 2008

(54) System and Method of Performing Remote Verification of a Prescription in Combination with a Patient Access Terminal

(75) Inventors: Tomson George, Wheeling, IL (US); Randolph V. Veloso, Machesney Park, IL (US)

Correspondence Address: FRANCIS C. KOWALIK;WALGREEN CO. LAW DEPARTMENT, 104 WILMOT ROAD, M.S. #1425, DEERFIELD, IL, 60015, US

(73) Assignee: WALGREEN CO., Deerfield, IL (US)

(21) Appl. No.: 11/759,534

(22) Filed: Jun. 7, 2007

(51) Int. Cl. G06Q 50/00

(52) U.S. Cl. 705/2

(57) ABSTRACT

The method and system provides a patient access terminal to collect customer and prescription order data, and enables a product work order to be divided into portions that may be routed to and processed by a plurality of entities including a customer, while providing verification processing to ensure the integrity of a delivered product.

### FIELD OF THE INVENTION

The present disclosure generally relates to a process for managing prescription order workflow in a pharmacy network.

### BACKGROUND

Generally, prescription drug orders are received at a physical store location and traditionally, the entire prescription order is processed at the single store location. Because physical stores are grounded at a particular location, the drop-off of prescription orders may be an inconvenience for a customer where the store location is not suitably located in relation to the customer's preference. Moreover, differences in the characteristics of different stores in a pharmacy network and the number and types of transactions processed by different stores in the network may result in inefficiencies when only a single physical store receives and completely processes each prescription order. Currently, there is no way for a pharmacy network to benefit by more efficiently using its network resources and customers to efficiently distribute work.

### SUMMARY OF THE INVENTION

The method and system provides a kiosk or patient access terminal to collect customer and prescription order data, and enables a product work order to be divided into portions that may be routed to and processed by a plurality of entities including a customer, while providing verification processing to ensure the integrity of a delivered product.

Prescription order data, which may take the form of an unprocessed, electronic prescription image, is inputted (e.g., scanned) into a kiosk or patient access terminal conveniently located to a customer. An image object of the scanned prescription image is formed and associated with a task object that is used to capture work performed on the prescription order as the order is routed to various network resources.

Verification of the prescription order may be performed using the image object by for example, a remote pharmacist, and/or by a customer at the kiosk or patient access terminal. The method and system provides image data from a first location to a second location and enables a product verification process to be performed by a user remote from the location of a physical product undergoing the verification process. The method and system enables the verification process to be ported to locations in which resources may be more efficiently utilized. Separation of an information processing portion of the verification process from the overall product filling process may allow the order filling process to be more easily divided and distributed to one of a plurality of entities.

This system enables flexible pharmacy organization planning and allows for implementation of different workflows for different types of work orders. While the specific method and system will be described to apply to a pharmacy retail network embodiment, it is emphasized that this process may be applied to other retail network systems that require original order data to be referenced during the processing of a work order.

### BRIEF DESCRIPTION OF THE DRAWINGS

FIGS. 1-3 illustrate block diagrams of a computing system that may operate in accordance with the described embodiments;

FIG. 4 illustrates a workflow for a traditional pharmacy store;

FIG. 5 illustrates a data composition diagram for pharmacy information processing;

FIG. 6 illustrates a distribution system and method that may divide the information processing workload for a prescription order process;

FIG. 7 illustrates a pharmacy routing process based on delivery preference;

FIG. 8 illustrates a pharmacy routing process based on payment information;

FIG. 9 illustrates an order information verification workflow for a pharmacy network;

FIG. 10 illustrates a system for enabling remote verification of a prepared product;

FIG. 11 illustrates a verification process for prepared pharmacy products; and

FIG. 12 illustrates a flow diagram of a verification process for prepared pharmacy products.

FIGS. 13-26 illustrate various exemplary screen shots that may be used in conjunction with a patient access terminal.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

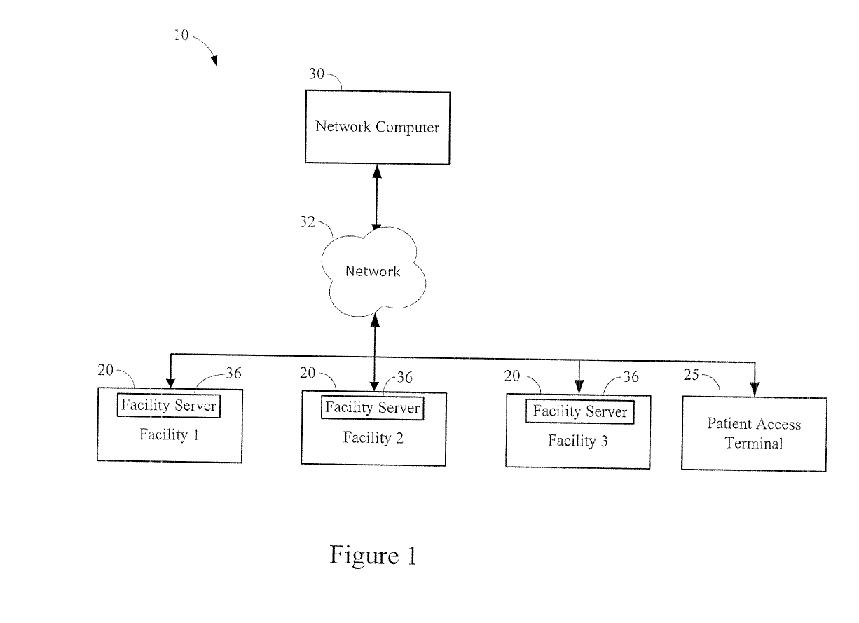

FIG. 1 illustrates an embodiment of a data network 10 including a first group of pharmacies 20 operatively coupled to a network computer 30 via a network 32. The plurality of pharmacies 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download pharmacy data. For example, the network computer 30 may periodically receive data from each of the pharmacies 20 indicative of information pertaining to a prescription order, billing information, employee data, etc. The pharmacies 20 may include one or more facility servers 36 that may be utilized to store information for a plurality of customers/employees/accounts/etc. associated with each facility.

Although the data network 10 is shown to include one network computer 30 and three pharmacies 20, it should be understood that different numbers of computers and pharmacies may be utilized. For example, the network 32 may include a plurality of network computers 30 and hundreds of pharmacies 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating pharmacy data.

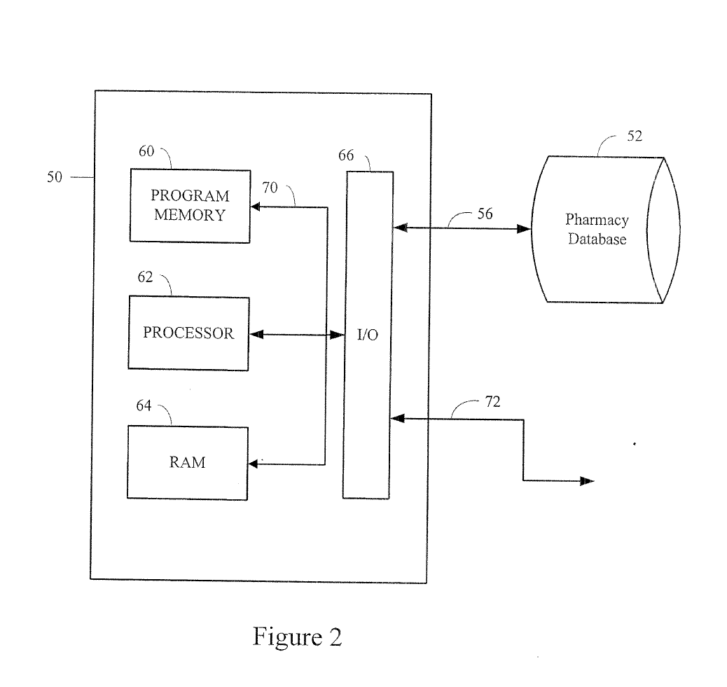

FIG. 2 is a schematic diagram of one possible embodiment of the network computer 30 shown in FIG. 1. The network computer 30 may have a controller 50 that is operatively connected to a database 52 via a link 56. It should be noted that, while not shown, additional databases may be linked to the controller 50 in a known manner.

The controller 50 may include a program memory 60, a processor 62 (may be called a microcontroller or a microprocessor), a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

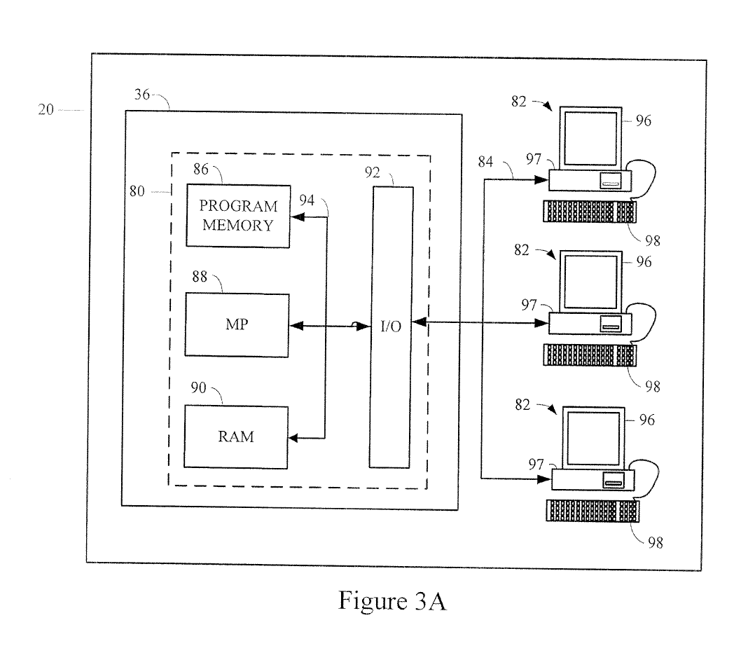

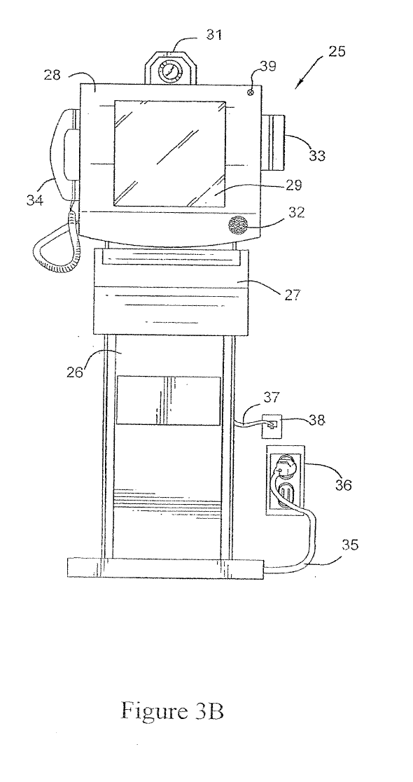

FIG. 3A is a schematic diagram of one possible embodiment of several components located in one or more of the pharmacies 20 from FIG. 1. Although the following description addresses the design of the pharmacies 20, it should be understood that the design of one or more of the pharmacies 20 may be different than the design of other pharmacies 20. Also, each pharmacy 20 may have various different structures and methods of operation. It should also be understood that the embodiment shown in FIG. 3A illustrates some of the components and data connections present in a pharmacy, however it does not illustrate all of the data connections present in a typical pharmacy. For exemplary purposes, one design of a pharmacy is described below, but it should be understood that numerous other designs may be utilized.

The pharmacies 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a scanner, printer, mouse, touch screen, track pad, track ball, isopoint, voice recognition system, digital camera, etc. Each client device terminal 82 may be signed onto and occupied by a pharmacy employee to assist them in performing their duties. Pharmacy employees may sign onto a client device terminal 82 using any generically available technique, such as entering a user name and password. If a pharmacy employee is required to sign onto a client device terminal 82, this information may be passed via the link 84 to the facility server 36, so that the controller 80 will be able to identify which pharmacy employees are signed onto the system and which client device terminals 82 the employees are signed onto. This may be useful in monitoring the pharmacy employees productivity.

Typically, facility servers 36 store a plurality of files, programs and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

FIG. 1 also illustrates a kiosk or patient access terminal 25 that may form a portion of the data network 10. As used herein, the term “patient access terminal” is hereby defined to mean any sort of terminal or kiosk capable of receiving data associated with a prescription, a patient, or a customer. The patient access terminal 25 may be directly coupled to the network 32 or, alternatively, may be a client device terminal coupled to a facility server 36, as illustrated in FIG. 3A. The patient access terminal 25 may include a display 96, a controller 97, a keyboard 98 as well as a variety of other input/output devices such as a scanner, credit card reader, printer, mouse, touch screen, track pad, track ball, isopoint, voice recognition system, digital camera, electronic storage device reader (e.g., flash drive interface or magnetic media reader), etc. Each patient access terminal 25 may be placed at any location that provides a suitable connection to the network 32, not necessarily a pharmacy location. The patient access terminal may be accessed by any customer. Although only one patient access terminal is illustrated in FIG. 1, a plurality of patient access terminals may be connected to the network 32.

FIG. 3B illustrates a possible patient access terminal embodiment that may be used in the claimed system. The patient access terminal 25 includes a housing and base portion 26 which houses a computer system having software thereon that controls the operation of the patient access terminal 25 in the manner described herein. The computer system may be any suitable type of computer system. Mounted on the housing portion 26 is a computer monitor 28 having a display with a touchscreen 29. One or more speakers and microphones 32 may also be provided on the patient access terminal 25 at any suitable location. A camera 31 may be mounted on the top of the computer monitor 28 and may be oriented to video a customer standing at the patient access terminal 25. The speaker, microphone 32 and camera 31 may comprise a videoconference system for the patient access terminal 25. A bar code scanner and printer may also be included (not shown)

A card reader, such as a credit card reader 33, may also be operatively mounted on the side of the computer monitor 28. A handset 34, preferably in the form of a telephone handset, may also be mounted on the patient access terminal 25 for use by the customer when additional privacy is needed. The patient access terminal 25 may further include a scanner 27 operable to scan documents and the like. The computer system monitor, videoconference system, card reader, handset and document scanner may all functionally interconnect to perform the functions described herein. The patient access terminal 25 may be powered by a conventional power outlet 36 using a power cord 35. The computer system may also include a communication system that is operable to communicate over any desired communications medium using communication line 37. For example, the communication line 37 may be connected, via outlet 38, to a T1 telecommunications line for high-speed communications (e.g., to a network). A motion sensor 39 may also be provided on the patient access terminal 25, for example, to activate the patient access terminal when a customer is near.

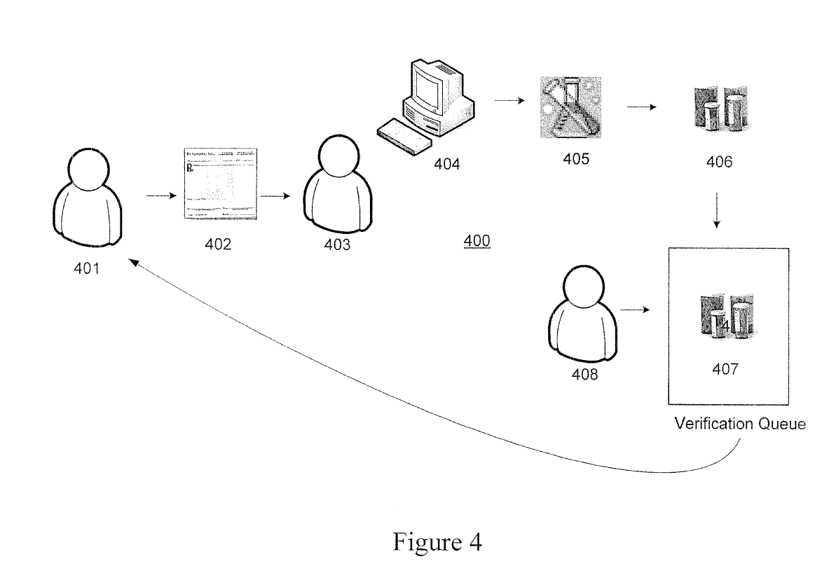

FIG. 4 illustrates a workflow for a traditional pharmacy store 400. Even though this pharmacy store may be part of a large network of affiliated stores, the pharmacy store may only process each locally received prescription work order in-house independent of any other store. A first pharmacy resource 400 may include, for example, a pharmacist, a technician or non-pharmacist assistant 403 that receives a physical prescription 402 from a customer 401 and inputs the prescription order 402 into a computer 404. The pharmacist 403 may contemporaneously begin physical preparation of the pharmacy product for the prescription order 405. After the physical pharmacy product is prepared 406, but before the product is delivered to a customer 401, the prepared pharmacy product 406 may be placed in a physical verification queue 407 or storage container. The pre-verification product orders in the verification queue 407 may await a registered pharmacist 408 to perform verification. After a verification process by a registered pharmacist 408, the pharmacy product may be approved for delivery to the customer 401 that placed the order at the same store.

Order entry may be the most time consuming portion of the order filling process as each paper prescription is manually entered into the system by a pharmacy employee 403 who reads the prescription 402 and contemporaneously performs all the information processing steps (e.g., authentication, validation, inventory check, etc.) and physically prepares 405 and delivers the drug product 406. Because of the need for evidence of an original prescription order document (e.g., to verify a physician's authentication of a prescription order and/or the need to verify that the correct drug product for an order coincides with the prescription order) physical prescription orders have normally been received at a physical pharmacy store location and physically tied to the order filling process. However, this may be inefficient for a network of pharmacy resources that may have differences in equipment, inventory, and personnel expertise to process a prescription order and may be an inconvenience for a customer who needs to travel far to a store location to drop off a prescription.

To alleviate differences in store capacity (e.g., equipment, personnel, inventory) and increase customer convenience in order process initiation (e.g., more convenient point of sales), the prescription order processing workflow may be broken into portions that are more efficiently managed by and distributed to different entities, including a customer placing the order. A distributed processing scheme in which different entities (e.g., pharmacy resources and customers) process different portions of a single work order may increase system efficiency.

FIG. 5 illustrates that processing of a work order for a physical product 500 may involve physical processing steps 501 and information processing steps 502. Information processing 502 may include entering the original prescription order data into a system 503 as well as all the steps that need to be performed to the order data 504 contemporaneously with physical preparation of the pharmacy product 501. Some of the information processing 502 may include work related to inputting prescription data 505, authenticating the prescription order 506, validating customer information 507, processing payment information 508, investigating insurance 509, verifying prescription order information 510, verifying physical product correspondence and integrity 511, and recording accounting information into an accounting database 512.

Because information processing of the order may not need to be performed at a particular location, the information processing portion of the order fulfillment process may be distributed to other organizational units for execution. To enable geographic separation of workflow in which different entities and geographically separated personnel work on portions of a single prescription order, the pharmacy information system and method divides work into discrete units that may be distributed. As discussed above, the difficulty in dividing work in retail businesses that transact in paper work orders is that these work orders sometimes carry inextricable evidentiary relationships to a set of order processing steps. In a pharmacy business, for example, processing of a physical prescription may require constant reference to the original prescription document for verification and analysis, where the prescription document represents original order data and authorization to distribute a drug. In other words, order entry, which forms a significant portion of the information processing, may be broken into discrete steps, but because each step requires reference to original order data, order entry has not been easily separated in prior systems that generally require order entry and information processing to be entirely performed in one step and at one location.

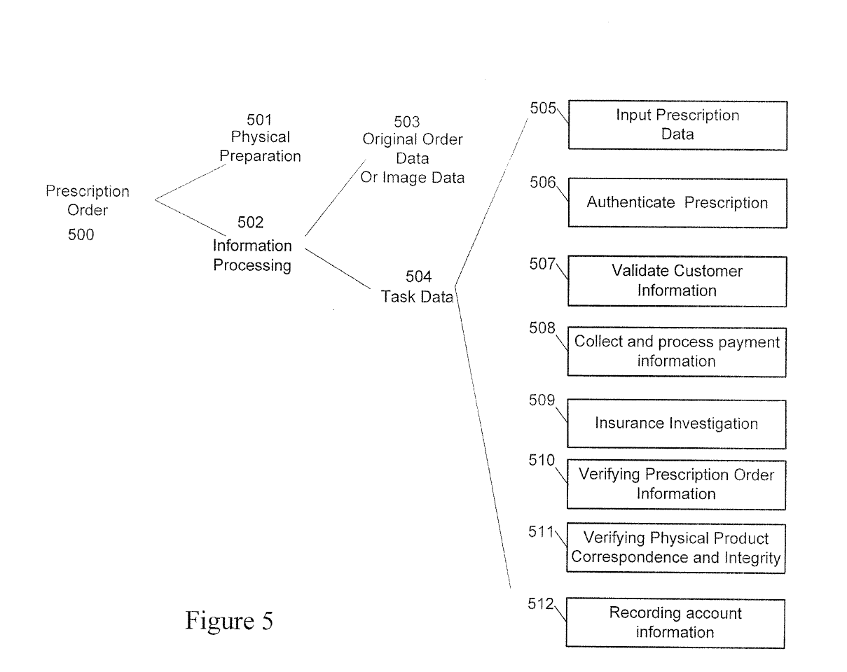

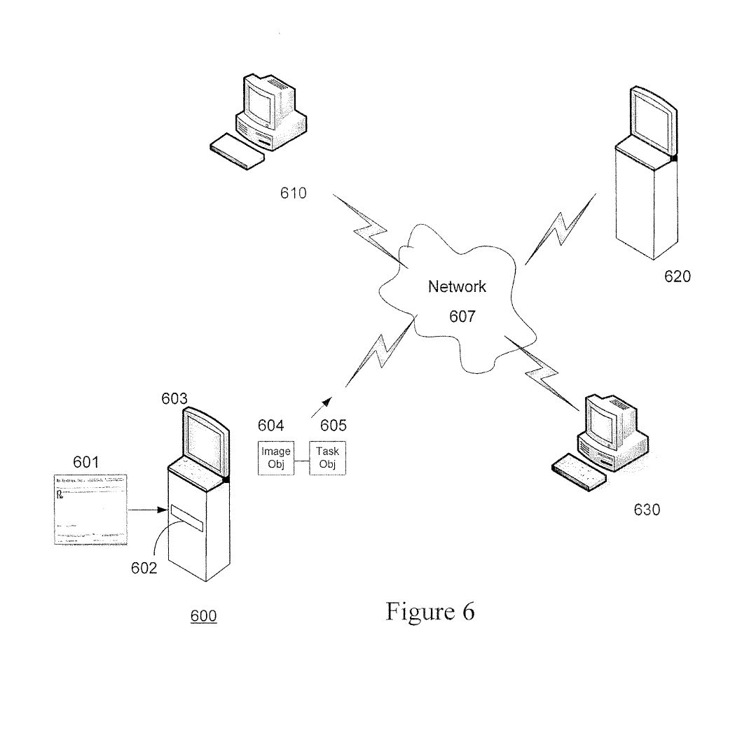

FIG. 6 illustrates a distribution system and method that may divide the information processing workload for a prescription order process. As discussed above, in order to divide the overall prescription information process into distributable portions, an ability to reference the original order data is provided. FIG. 6 illustrates that a physical paper work order, such as a prescription drug order 601, may be scanned into a patient access terminal computer 603 (e.g., using a scanning device 602) at a location 600 convenient to a customer, but remote from any pharmacy resource. The scanned prescription order may form an electronic image object 604 of the prescription order 601. This image object represents original order data that may be needed to perform other steps of the work order process. In other embodiments, additional documents such as certificate of medical necessity (CMN) forms, insurance cards, and laboratory results may also be scanned and captured by the original order data object.

Referring again to FIG. 5, it is illustrated that information processing of the order can be decomposed into capturing original order data 503, such as an image of the prescription order, and processing task data 504. The task data may be divided into portions of work performed to the original order data 503 to complete information processing 502. These tasks may be encapsulated into a single program entity called a task object 605, as shown in FIG. 6. The task object 605 may be used to carry and save the work performed on the prescription order, as represented by the image object 604, for each step of the order process. The task object may enable information processing to be distributed to different entities by being routed from one network entity 603 to another 610-630, including another patient access terminal 620. In an embodiment, the routing may be based on criteria such as a customer preference, product type, general pharmacy workflow, etc. (further discussed below). By capturing the physical prescription order 601 into the image object 604, the image object 604 may be used to provide information to process a task at each step of a workflow, without having to ground the entire process at one location. The information system may be adapted to changing workflows and multiple workflows simply by routing the task object 605 and/or image object 604 to any queue within a network system, where the queue may represent a processing step.

In one embodiment, the image object may be immediately sent over a network 607 to be stored in a central network server. A network computer (e.g. a client computer) may communicate with the central network server and may access the image object 604 using a reference, which may be stored in the task object 605. The task object 605 may be communicated between network computers (including other patient access terminals) to form a divided workflow, where each computer that receives the task object 605 performs a portion of prescription order work that is captured by the task object 605. Alternatively, the task object 605 may reside in a central network server and a reference to the task object 605 may instead be communicated to a computer to indicate that that computer is tasked to perform a portion of work. (A reference to the image object 604 may accompany the reference to the task object) For example, an e-mail message from computer A to computer B may indicate that computer B is tasked to perform a portion of work on the prescription order, where the email contains a reference to the task object, that will capture the work to be performed by computer B. In this case, computer B's email queue may act as a task queue.

In another embodiment, the image object 604 is stored in a central repository managed by a pharmacy network server and a reference to the image object 604, or a copy of the image object 604 is routed to a network client computer to indicate that the computer is tasked to perform a portion of work using the image reference or image object copy. In this embodiment, the task object 605 may be passed along with the image object reference or image object copy. Alternatively, the task object may be stored with the image object in the central repository and only a reference to the task object is routed with the image object reference or image object copy. For client computers that use slower data connections to a pharmacy network, instead of routing the task object 605, information entered using a copy of the image object 604 may be uploaded to the server computer that stores the task object 605 which is modified by the uploaded data.

The task object 605 may consist of a table in a database which stores the process information. Alternatively, the task object 605 may be a set of memory objects in a temporary computer memory that hold the work information temporarily until the task information is no longer needed, in which case the object is deleted, or until the task information is stored in a permanent medium.

As illustrated in FIG. 6, information may be received or collected from a user at a patient access terminal 603 at a location 600 (which may be different from network entities 610-630). In one embodiment, the user or customer may scan a physical prescription order into the patient access terminal 603. The scanned prescription order data may be used to form the image object 604, as described above. In some embodiments, the prescription order may not be paper-based. Instead, the prescription order may be in some recordable form and placed on a portable memory storage device. In this situation, the patient access terminal 603 may be configured with an appropriate input interface, such as a reader, to receive the original prescription order data. In either a physical or electronic form, the prescription order data may generally provide a mechanism for verifying the authenticity of the prescription order (e.g., be physically or digitally signed) and for verifying the physician's authorization of the order. Once the prescription order document is captured electronically to form the image object 604 an associated task object may be formed to capture further information collected during the order filling process. The task object 605 and image object 604 may then be routed or transmitted to a receiving pharmacy resource for processing.

In one embodiment, before the task object 605 and image object 604 are routed, the customer may enter further customer information at the patient access terminal 603. For example, the customer may provide personal identifying information, payment information, delivery or pickup selection, etc. The user may enter this information using a variety of different input devices. For example, the user may use a mouse to select various options indicating customer information. Alternatively, a user may use a touch screen device or keyboard to enter the additional information. The information may be requested by a program running on the patient access terminal 603 which provides a prompt to the user. The program may react to the information provided by the prescription and/or may be a standard flow process that is predefined. This will be further discussed below.

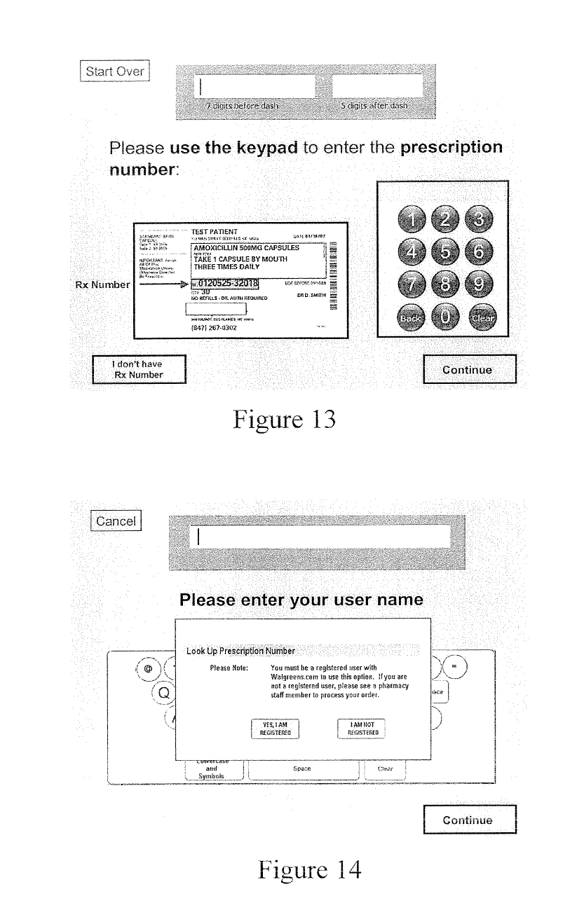

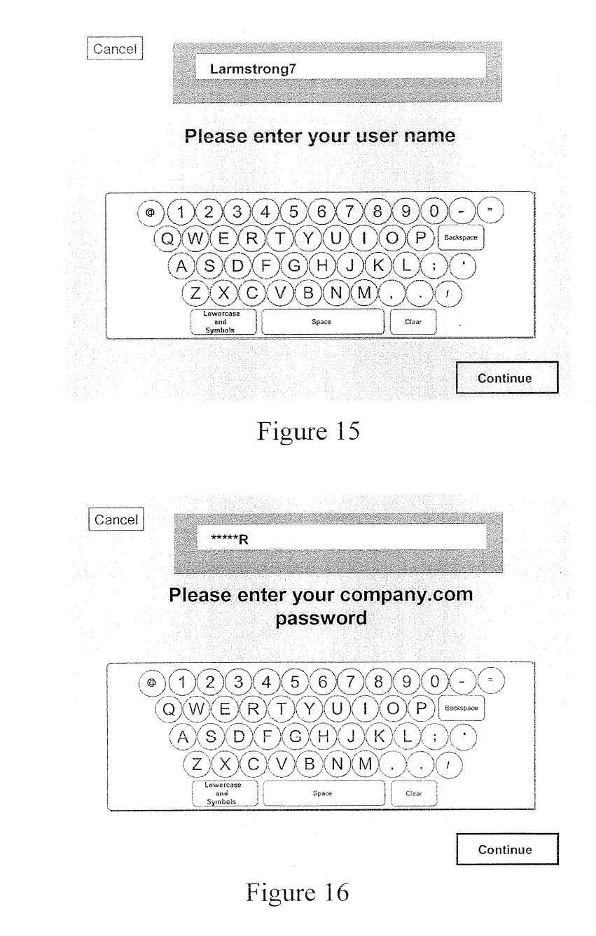

In one embodiment, customers may be limited to certain types of transactions that they may perform at the patient access terminal 25, such as for example, (1) refill a prescription, (2) enter a new prescription, and/or (3) both refill a prescription and enter a new prescription. If the customers select the option to refill a prescription, they may be taken to a Refill Entry Window where they are prompted to enter their prescription refill number. FIG. 13 illustrates an exemplary screen shot of a graphical user interface that allows a customer to enter a prescription number. The customers that select the option to refill a prescription may also choose to view their account profile if they are currently registered users. The customers can input this information using the exemplary screen shot illustrated in FIG. 14. If the customers are validly registered users with access to their profiles, the system may prompt them for their username and password. FIGS. 15 and 16 illustrate exemplary screen shots that can be used by a customer to input a username and password.

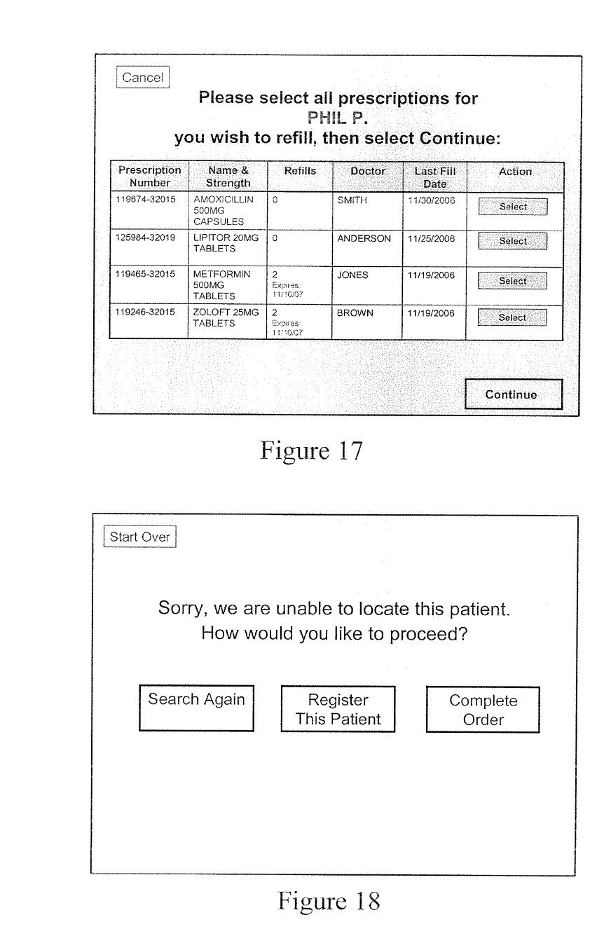

Once the system successfully validates a user by authenticating the username and password, the system will retrieve a patient profile for a patient associated with the customer and display to the customer the drugs that they can refill. FIG. 17 illustrates an exemplary screen shot of a patient's Profile Screen. The patient's profile screen displays a list of drugs that can be refilled.

If the customer selects the option to enter a new prescription, or begins the “new” process after entering their refills, the customer may be required to search for a patient for which they want to fill a prescription. To search for a patient, the system may be configured to prompt the customer to enter a last name, a telephone number, and a date of birth for the patient they wish to enter or scan a prescription under. If a unique match for the patient is not found in the system, an error message screen, such as the exemplary screen shot illustrated in FIG. 18, is displayed indicating that the patient could not be found in the system. The customer may then be provided with the option to choose to re-enter the information and search again or completing their order if they already have scripts entered.

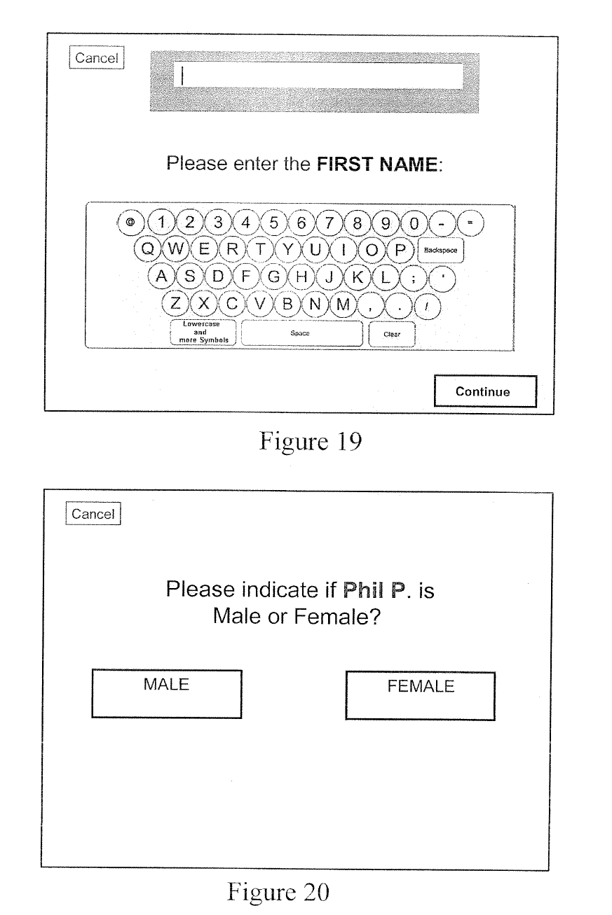

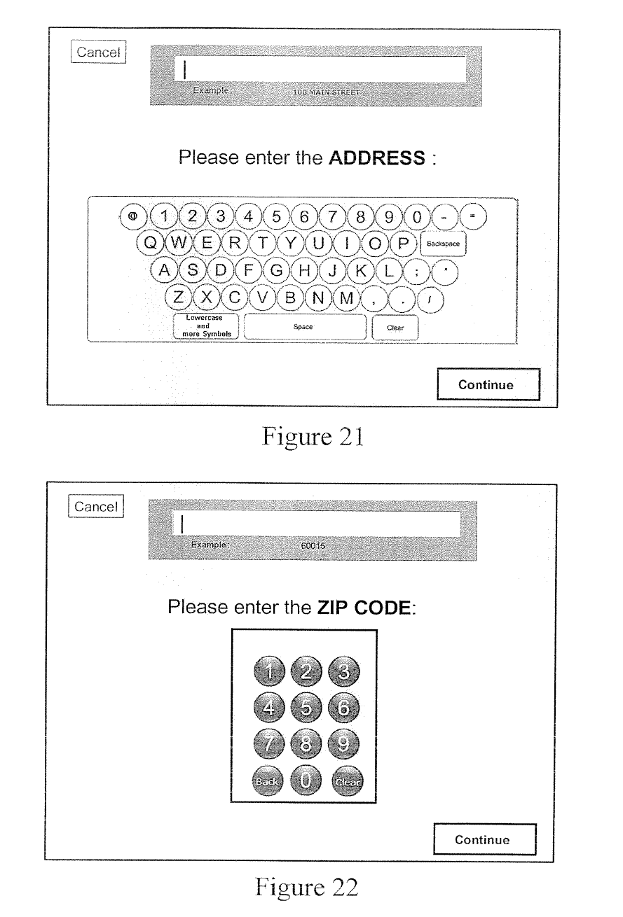

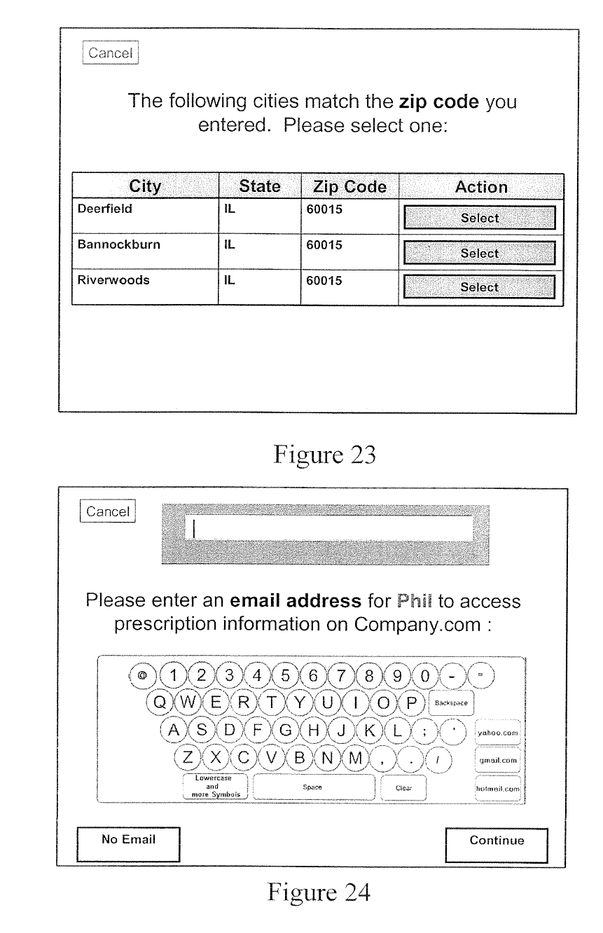

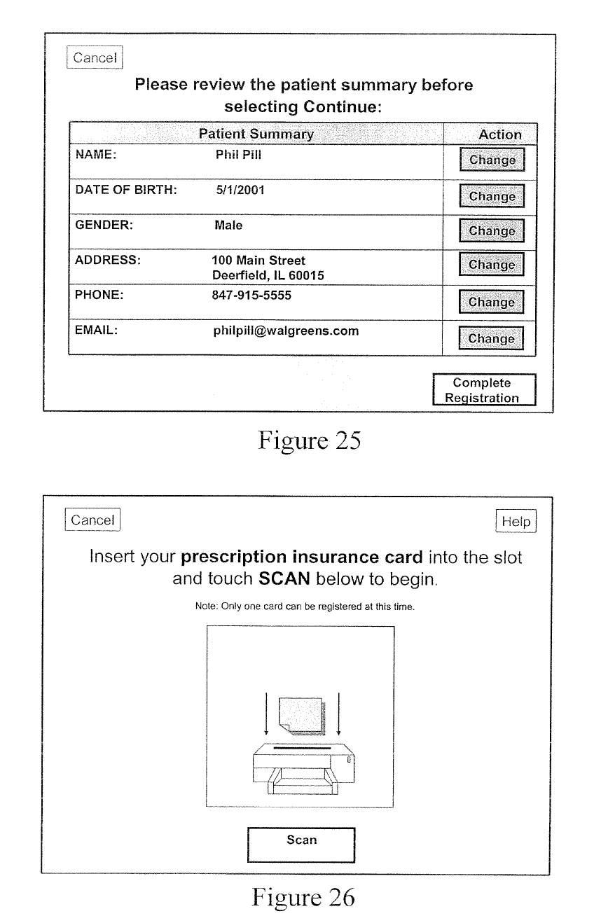

If no data is returned from the patient search, the customer may be given the option to register the patient that they attempted to search for previously. The customer may then be prompted to enter the following additional information: (1) First name, (2) Gender, (3) Home address, (4) Zip code of residence, (5) City and State (if multiple matches from zip code), and (6) Email address. The exemplary screen shots illustrated in FIGS. 19-24 may be used in conjunction with the retrieval of the above additional information. When the above additional information has been retrieved and stored in a memory, a final screen may be displayed for the customer to review the information and make any changes if necessary. FIG. 25 illustrates an exemplary screen shot of such a screen. If any of the changes include the last name, date of birth, or phone number, the system will perform another search for the patient to ensure that the new data matches with a patient already in the system. The patient will then be registered. After successful registration, the patient may be prompted to scan their primary insurance card. This is illustrated in an exemplary screen shot shown in FIG. 26. Thereafter, the customer may be allowed to scan a prescription for filling.

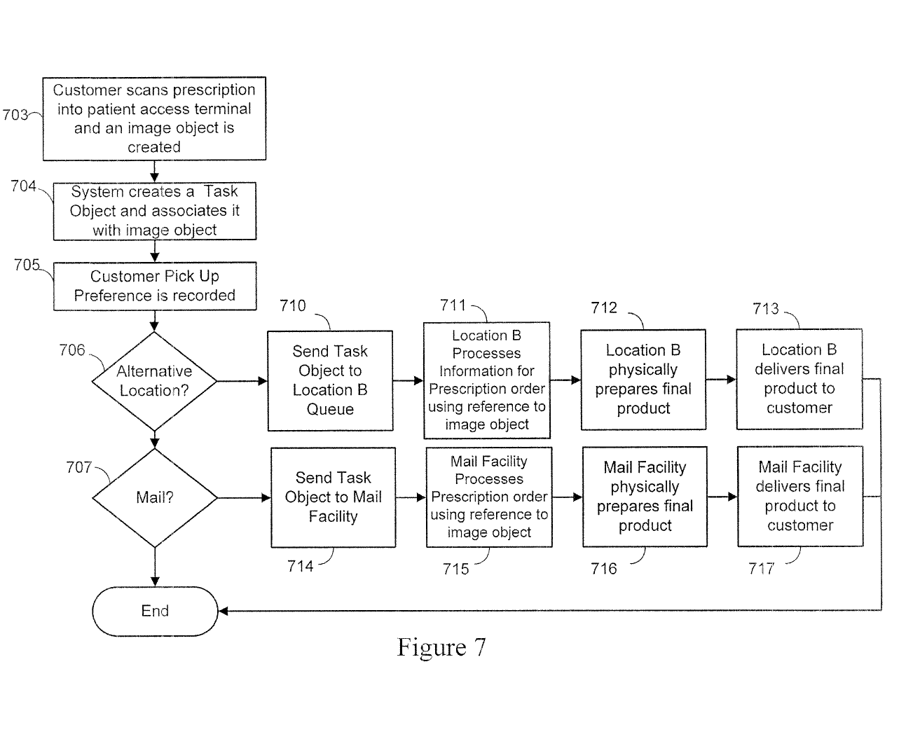

The prescription order task object 605 and image object 604 may be routed for processing at a number of pharmacy resources based on a number of criteria. One such criteria or factor is a customer's pharmacy delivery preference, which is illustrated in FIG. 7. A customer may begin the prescription order process at a patient access terminal by scanning the prescription order, thereby creating an image object (703). In this embodiment, the image object may contain at least one image of the prescription. Next, the system creates a task object and associates the task object with the image object (704). The task object may contain registration information. It should be noted that in a further embodiment, a portion of the information inputted by the customer may form an account data object and the account data object may be associated with the task object 605 as well as the image object 604. The customer's preference for an alternative pickup location is checked (705, 706) and the task object is routed to a pharmacy at location B (710), different from the patient access terminal location and a default location displayed by the patient access terminal. The task object may then be sent with the image object or with a reference to the image object. Location B receives the task object in its work queue (710) and begins information processing the prescription order by referencing the image object (711). After the information processing is performed, physical preparation of the drug may be performed (712) and a final product may be delivered to the customer at location B (713). Alternatively, some pharmacy companies offer the option to mail a drug to a customer. In this case, a customer's preference for mailing may be determined (707), and the task object and image object or reference may be sent to a mail processing facility (MPF) (714). The MPF (714) performs similar processing to the alternate location processing described above, e.g., information processing (715), and physical preparation (716), except the delivery is performed by mailing the final product to the customer (717).

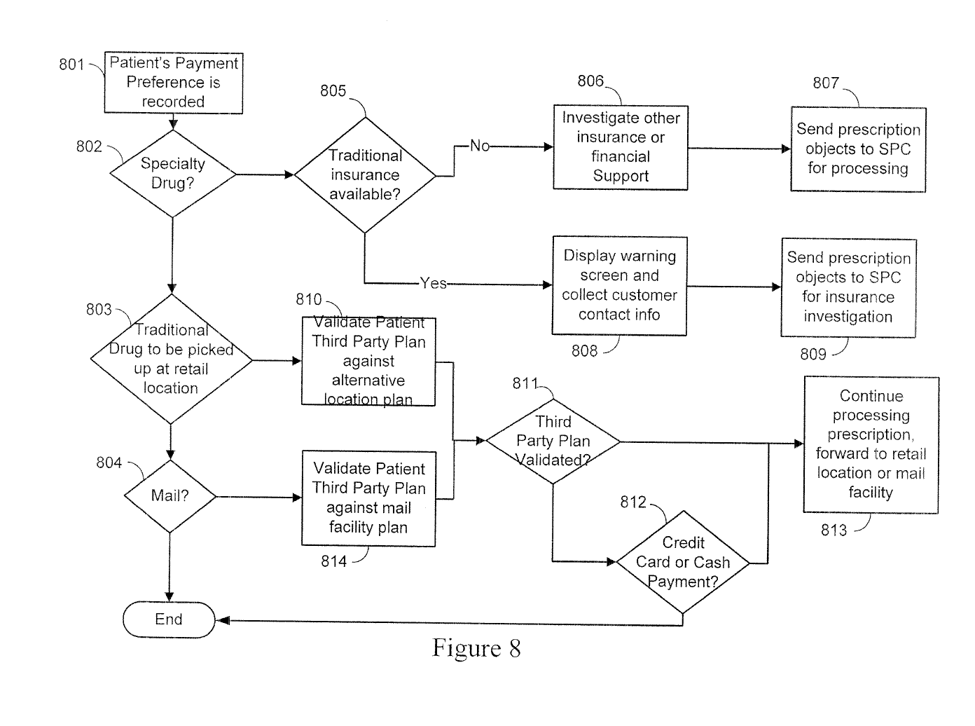

Another factor in determining routing and workflow may be payment processing. FIG. 8 illustrates a payment system embodiment. A customer dropping off a prescription at a patient access terminal may select a payment method (801) as part of an initial prescription order placement. Prepayment options may include, for example, a third party insurance plan, cash, a check or a check equivalent, or a credit/debit card. Alternatively, in some instances, the customer may decide to make a payment where the prescription is fulfilled. In some cases, such as with specialty drugs, additional processing may be required. Specialty drugs may be drug products that require a particular handling process by certain personnel special equipment, or special material from inventory. In this embodiment, specialty drugs may also require a certain payment handling process.

A check to determine if the prescription involves a specialty drug is made at 802. If the prescription order does involve a specialty drug, then block 805 determines if traditional insurance may be available for the drug. If traditional insurance is available, an indicator may indicate that insurance is available based on general insurance parameters, but that additional information must be collected and verified (808). The information collected may then be sent to a special processing center (SPC) for processing (809). In some cases, traditional prescription insurance may not cover some specialty drug products or a customer may simply be uninsured. The retail pharmacy may offer an option to investigate alternative financial options, such as non-traditional prescription insurance (806). In instances where non-traditional insurance may be an option, an embodiment may simply collect customer contact information and pass the order to an SPC to finish processing, e.g., by performing an insurance investigation or other third party payor investigation 807.

For traditional prescriptions that will be delivered to a customer at a retail location 803, a third party plan may be validated based on data associated with the retail store's insurance plans (810). If the third party plan is validated (811), the prescription continues its regular processing (813). If validation fails, then alternative payment options may be processed (812). For prepayment situations involving cash, a check or a check equivalent, or a credit/debit card, the patient access terminal may be configured to accept and process the prepayment and simply record that the order has been paid. If validation is successful, prescription processing continues (813). If no payment method is available to the customer, the order processing may end. If the prescription is to be mailed (804), the same process applies, except that the third party validation may occur against a mail facility's third party plan (814).

In a patient access terminal embodiment, a customer enters a prescription order at a patient access terminal at a first location A and then accepts delivery at a second location B, e.g., a pharmacy. A confirmation document may be preferably printed by the patient access terminal at location A and delivered to the customer after the receipt and initial processing of the prescription order at the patient access terminal. The order confirmation document may be printed at the patient access terminal with Location B information. The confirmation document may provide proof of payment, if prepayment was made at Location A. Otherwise, the confirmation document may simply identify the prescription order using, for example, a prescription identifier. The prescription identifier may be a bar code printed on the prescription order such that a pharmacist at a pickup location may simply scan the confirmation document (e.g., using a computer at location B) to retrieve prescription status information, e.g., retrieve the task object and/or image object.

In one embodiment, customers may take their order confirmation document to any non-fulfillment store to pre-pay their prescriptions. The order confirmation document may include identifying reference information, such as a prescription identifier, that may be used at a particular pharmacy resource to access a task object and/or image object for a prescription associated with the document, where the task object may contain payment information. The prescription identifier may correspond to an identifier parameter contained in the task object. This identifier parameter may be used for authentication purposes. Alternatively, the task object may be associated with a customer object that contains this information. Scanning the bar code may initiate a request by a computer at a pharmacy location to have the task object routed to that location.

The task object may be in a first queue associated with a network computer of a first pharmacy (e.g., a prescription drop-off location or a preferred pick-up location) and routed to a queue of a second computer at a different pharmacy for payment or prepayment (e.g., before a prescription is ready for pickup). A pharmacy employee may scan the bar code on the order confirmation document to determine if the customer has paid any amount for the prescription and deduct that from the total sale price of the prescription order. Alternatively, a customer may have the bar code on the confirmation document scanned at a patient access terminal, where the patient access terminal will indicate whether the customer has paid any amount for the prescription and display a remaining amount owed (after deducting from the total sale price the amount paid). The customer may then pay in full or partially pay the remaining balance. The task object or associated customer object may be updated accordingly with the payment status. This may involve adjusting a customer debit account associated with the task object for the prescription.

Customers may also take their order confirmation document to a fulfillment location or a patient access terminal to inquire on the status of their prescription. The pharmacy employee at the fulfillment store or the customer at the patient access terminal may scan the barcode on the order confirmation document to retrieve the order information. The system may return the status of the prescription, including the payment status. At a fulfillment location, if the status of the prescription is paid in full (which may be indicated by displaying a dispensing permission indicator at a network computer), then the prescription may be delivered to the customer at that time. If there is a balance, the customer will be required to pay the balance first, before the prescription is dispensed. If there is an overpayment (e.g. for an adjustment from a third party plan payment), the customer may be refunded the overpayment at delivery time. The order confirmation documents may not only serve as proof of payment, the document may also be used to authenticate the customer for specialty drugs.

In the case of a refund, the bar code of an order confirmation document may be scanned by a pharmacy employee at a pharmacy location. If the prescription has a SOLD status, a refund without prescription may be blocked. In this case, a prescription label may be needed in addition to the confirmation document for a refund, in order to ensure that a physical prescription is returned to a facility. Refunds for a prescription routed to another store before SOLD status may occur at any time. Refunds for a prescription routed to MAIL may only be done through a special mail return process. This special mail return process may involve returning the drug to a mail fulfillment center or using a return envelope or box. Refunds for a script routed to another store after SOLD status may only occur at a fulfillment store that is designated to accept returns. Retail stores may all be designated as return capable or only a subset of retail stores may be designated as return capable based on efficiency and customer policy.

In one embodiment, the customer may be limited to prepaying only the full amount of the prescription, where partial prepayment is not allowed. In another embodiment, prepayment may only occur at a non-fulfilling location, such as a patient access terminal or pharmacy. For example, a delivery location may only deliver the product and may not be enabled to process payments. In this situation, payments must be made using a patient access terminal or at some other pharmacy.

Pre-payment may be made at any organizational unit in the network in which the task object may be routed for processing, thus enabling customers the option to pay for their prescriptions at any location. In another embodiment, Internet payment may also be an option. In this embodiment, an Internet application may be designed to interface with an account system for a pharmacy company. Alternatively, a customer may have created an express pay account, where a customer has registered an account in which funds may be automatically deducted whenever a prescription has been entered. In this case, prepayment is automatic.

Other factors that may influence routing may include workload of a pharmacy resource and availability of inventory, equipment, and specialized personnel to process a prescription order.

### Verification

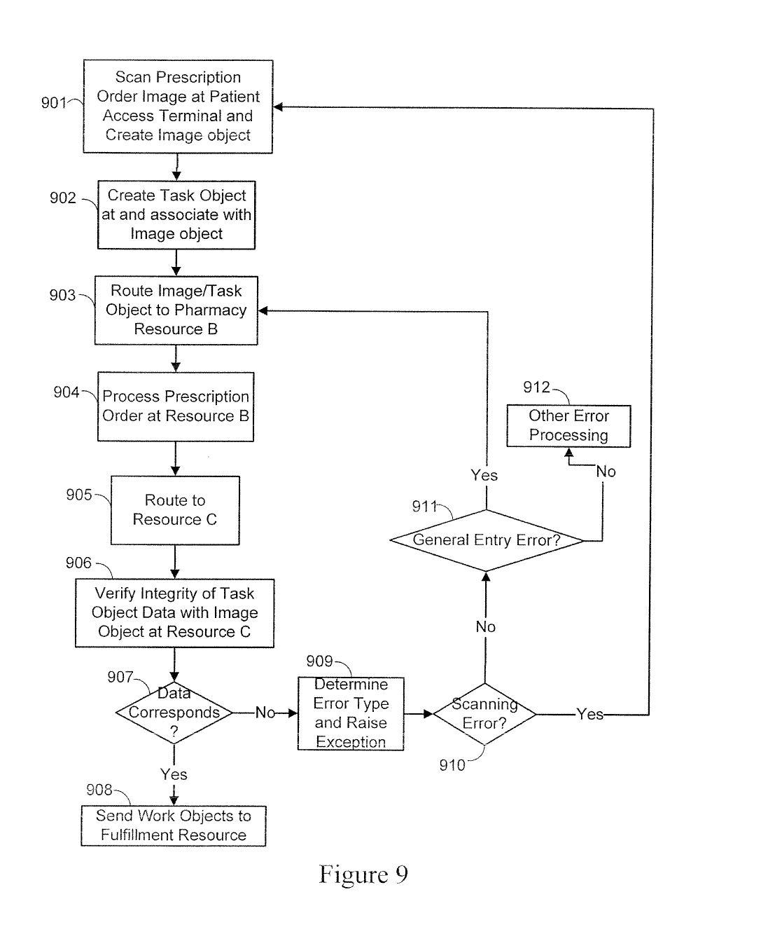

While quality of product is important in most businesses, quality of product is especially important in the pharmacy business where drug safety is critical. Because accuracy of prescription data is critical in producing a safe drug, in addition to entering data based on original prescription data, information processing may require verification of entered data. FIG. 9 illustrates a possible prescription verification process. An image may be scanned in at a patient access terminal (a first pharmacy resource) and captured by an image object (901), which is then associated with a task object (902). The prescription order objects (e.g., image/image object and task object) may be sent to a second pharmacy resource (903) for a portion of order processing (904) before being sent to a third pharmacy resource C (905) for verification processing (906). Verification may be performed by specialized pharmacists/or other trained pharmacy agents that primarily focus on verification processing. These verification specialists may be online to handle prescription orders as the customer is entering the order at a patient access terminal. In one embodiment, prescription verification may be performed contemporaneously with the customer's order entry process at the patient access terminal.

Verification may entail examining a prescription image and reviewing entered or translated data to ensure that the information in image form corresponds to data stored in an associated task object. If the data matches (907), then the prescription order objects may be routed to a pharmacy resource for fulfillment (908). If the data does not correspond, then the pharmacy resource may determine the type of error and raise an exception (909).

In one embodiment, the prescription order may be routed to a pharmacy resource based on the error type. For example, if a scanning error occurred (910), the prescription order objects may be routed back to the patient access terminal. If the exception involves a discrepancy that may be resolved by a customer and the verification specialist is online, then a message may be sent to the patient access terminal to prompt the customer to resolve the discrepancy. If a general data entry exception occurs (911), the prescription order objects may be routed back to a pharmacy resource (e.g., pharmacy resource B) that performed the data entry. Other error types may also be processed (912).

A data exception parameter may be used to indicate whether an inconsistency is detected during the verification process and the nature of the inconsistency. Various errors may cause an inconsistency between original order data captured in the image object and the data contained in a task object. A scanning error is one type of error. A scanning error may indicate that a scanned image in the image object may have poor quality and is unreadable. An entry error is another type of error. An entry error may be caused by a pharmacist, a technician, or other personnel entering information at any stage of the process. When a data entry error is detected, the source of the error may be determined, for example, by using a log of users involved in each step of the work process. Data entry errors may themselves be tallied and recorded as well. The routing of the prescription order objects may be based on the exception parameter. For example, when the exception parameter indicates a scanning error in which the image object is unreadable, the image object and/or task object may be routed back to a location or a pharmacy resource that first originated the order or that first scanned the image. In another example, when the data entry error indicates a data entry error for a portion of work, the prescription order objects may be routed back to a pharmacy resource that performed the portion of work and/or that is responsible for the portion of work.

In one verification embodiment, a log of data entry errors by a pharmacy resource may be used to calculate an accuracy measure for that pharmacy resource. The pharmacy resource accuracy measure may be used to determine pharmacy resource efficiency. Routing may be further based on the accuracy and/or efficiency of the pharmacy resource. For example, high risk drugs that may require less tolerance for error may be routed to higher accuracy pharmacy resources.

In another verification embodiment, certain automated checking of entered data may occur during a stage of the information processing. For example, text recognition software may be used to enter portions of the prescription. This may occur at the patient access terminal. In this case, an image of a prescription order may be scanned in and inputted to the text recognition software. The software may output a text file of entered data corresponding to the scanned prescription image. The verification process may then begin on the outputted electronic text. The electronic text may be placed in a task object before the verification process or the electronic text may be verified first before creating a task object to capture the verified text. In one embodiment, the patient access terminal may begin translating at least a portion of an image object w-hen the image object is formed. In a further embodiment, the patient access terminal may display a portion of the translated image of the prescription order (e.g., a customer identification portion) and prompt the customer to verify that the information is correct. This may place a portion of the burden of the verification process (when appropriate) on a customer.

A second aspect of verification involves ensuring that the physical pharmacy product delivered to a customer corresponds to identity and integrity of the pharmacy product designated by the prescription order placed by the customer.

In one embodiment, the patient access terminal may display a reference image of a sample of a pharmacy product as the customer is entering prescription order information at the patient access terminal. For example, the prescription order may contain drug identifying information such as a drug name, a drug type, and/or other drug characteristics. The drug identifying information may include a drug identifier such as a drug code that may identify the drug in a reference source (e.g., a physical index or database). The drug identifying information may be used to retrieve a reference image of the pharmacy product. In one embodiment, a reference image may be retrieved and displayed to the customer at a patient access terminal and the customer may be prompted to verify whether the reference image corresponds to the product that the customer is ordering.

Verification may also involve determining the identity of a prepared product in the verification queue (407) of FIG. 4 and comparing the pre-verification product to reference information of the product on the prescription order. In one embodiment, a patient access terminal may display an image of a sample of the pharmacy product prepared (e.g., a sample of the produce in the pre-verification queue) for delivery to the customer. This situation may arise, for example, when the customer checks order status at a time after the initial entry of his prescription order or via the Internet. This may happen at a patient access terminal different from the patient access terminal used to enter the original order. In one embodiment, the customer may still be able to accept or reject the prepared pharmacy product or at least raise an exception to the discrepancy in the ordered product and the image of the prepared product.

In another embodiment, verification may be primarily performed by a dedicated pharmacist. In this embodiment, the pharmacy system may provide a reference image that is retrieved in the same manner described above to the dedicated pharmacist for product comparison. Alternatively, the pharmacist may rely on the pharmacist's own knowledge of drug information for comparison. For example, the pharmacist may recognize the drug identifier or other drug identifying information and based on the pharmacist's knowledge of a characteristic of the prescription order product; examine the prepared product to determine if it corresponds to the product identified in the prescription order.

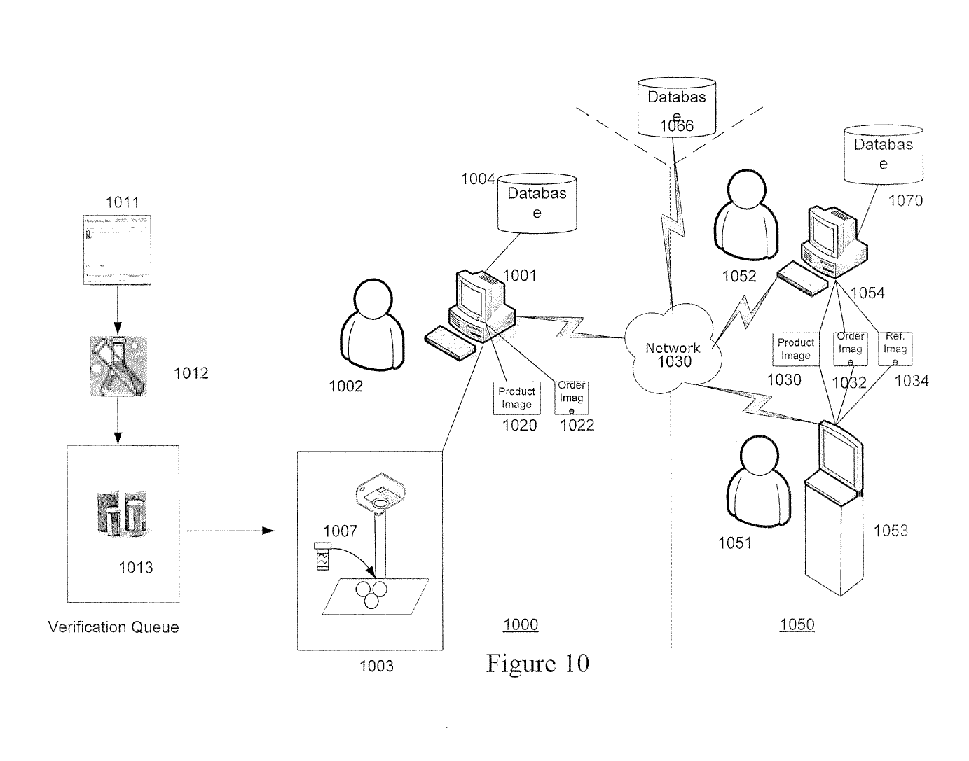

To enable geographic separation of verification work in which different entities and geographically separated personnel perform verification for a prescription order, the pharmacy information system and method acquires image data of a prepared pharmacy product for a remote pharmacist or customer to analyze. FIG. 10 illustrates a system embodiment for enabling remote verification of a product order, such as a prescription drug order. A first pharmacy resource 1000 at a first location may include a first computer 1001 that is connected to a pharmacy computer network 1030. The computer 1001 may be connected to a digital camera or other digital imaging device/system 1003. The digital imaging device 1003 may be used to scan a sample of a physical product 1007 that is associated with a prescription order 1011. This may be performed automatically or by an attendant 1002. This image data may form a product image object 1020.

In one embodiment, the sample may be taken from a prepared pharmacy product (produced via a physical preparation process 1012) in a pre-verification queue 1013. The product image object 1020 may then be stored on a local database 1004 or a central database 1066. The product image object 1020 may then be associated with an image object of a prescription order 1022 on the pharmacy network 1030. This product image object 1022 may include all the information from the physical prescription information.

A remote pharmacist 1052 located at second pharmacy resource 1050 having a second computer 1054 or a customer 1051 at a patient access terminal 1053 may then perform verification steps for the pharmacy product associated with the prescription order. The second computer 1054 or patient access terminal 1053 may be used to retrieve the prescription order image object 1032, an image of a sample product 1030 taken from a pre-verified prescription order product, and a reference product image object 1034, and display one or more of the images at the computer 1054 or patient access terminal 1053, or both. The remote pharmacist 1052 and/or customer 1051 may then inspect information in the prescription order image object 1032 to determine the identity of a customer requested product, and then, using personal knowledge or the reference image, determine whether the queued product corresponds to the order product. Once the remote pharmacist and/or customer determines that the products correspond (e.g., within a threshold) to the prescription order information, the remote pharmacist may provide an indication that the product is ready for release to a customer. If the product is deficient or defective, then the remote pharmacist 1052 and/or customer 1053 may raise an exception to the prescription order and provide an indication of the exception.

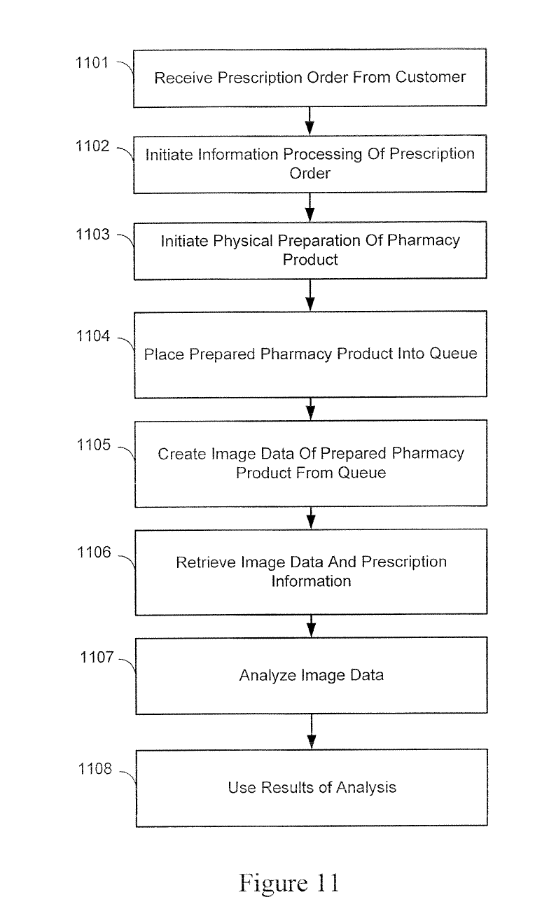

FIG. 11 illustrates a general process embodiment of the claimed system. In this embodiment, any pharmacy worker (e.g., pharmacist, technician, assistant) may receive a prescription order from a customer (1101), and initiate information processing of the prescription order (1102). Physical preparation of the pharmacy product (1103) may be initiated and performed contemporaneously with a portion of the information processing. Once the pharmacy product associated with a prescription order is prepared, the product may be placed in a verification queue (1104) and await verification. A pharmacy worker may then acquire image data of the pharmacy product to create an image data object of the pharmacy product (1105). A pharmacist or customer at a patient access terminal may then retrieve the image data along with prescription order information (1106) and perform an analysis on the image data using the prescription order data (1107). After the analysis is performed, the results of the analysis may be used to determine the next step of the order filling process (1108).

For complicated products that are not subject to customer verification, analyzing image data 1107 may involve an experienced pharmacist (e.g., 1052 in FIG. 10) referencing personal knowledge about a pharmacy product based on the prescription information and analyzing the image data based on this personal knowledge. The remote computer may also run an image comparison program that provides an analysis of two pharmacy product images. The image comparison program may match shape, size, and color of the pharmacy products to determine a correlation. In one embodiment, the image comparison program may provide a first estimate of the likelihood that the two products match and await input from the remote pharmacist before indicating approval of the product for delivery to a customer.

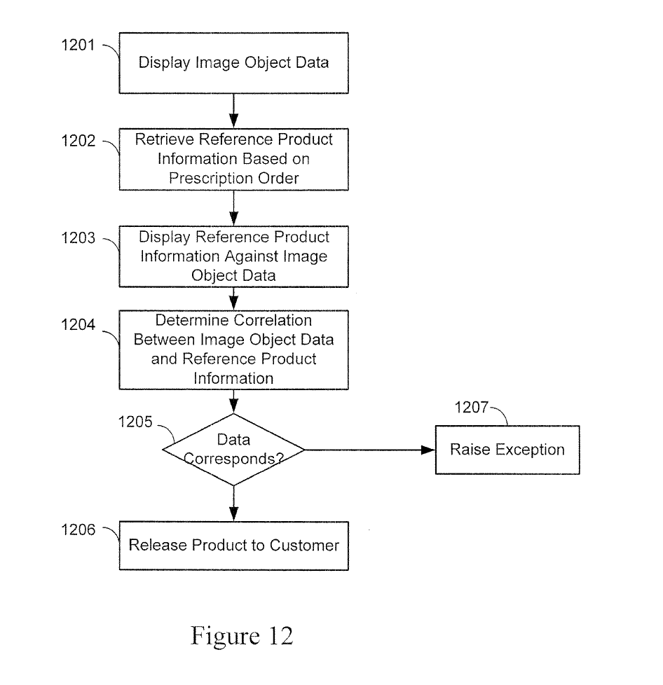

FIG. 12 illustrates an embodiment of a verification analysis process. A pharmacist at a remote pharmacy location or a customer at a patient access terminal may retrieve the image object and display it on a remote computer screen (1201). The pharmacist or customer may then reference a database 1004, 1066, or 1070 (see FIG. 10) to retrieve drug and/or product characteristic information (1202). The reference information, which may be in the form of a reference image object 1034, may provide images of the physical appearance of a drug or pharmacy product which the physician may then use to determine the identity of the product or the quality of the product. The reference data may contain image objects of drug and other pharmacy products that may be used in the analysis of the image data for the pre-verification product. The remote computer 1054 or patient access terminal 1053 used by the remote pharmacist 1052 or customer 1051, respectively, for verification may be adapted to display an image of the prepared pharmacy product and a reference image of a pharmacy product corresponding to information from the electronic prescription (1203). As illustrated in FIG. 12, the remote pharmacist 1052 may determine the correlation between the image data of the prepared pharmacy product awaiting approval and reference product data (1204). If the data corresponds within a certain degree or tolerance (or threshold) (1205), then the pharmacy product may be approved for release and delivery to a customer (1206). Otherwise, an exception may be raised (1207).

In an alternative embodiment, the verification system of FIGS. 10, 11, and 12, may provide additional measurements of characteristics of the sample of the prepared pharmacy product in the verification queue 1013. For example, in addition to a digital camera 1003, computer 1001 may be configured with various sensors that determine, for example, weight data, spectrographic data, olfaction data, pH data, toughness data, tensile strength data, composition data, temperature data, or humidity data for the sample product. In this situation the measured data may be contained in a sensor object and the reference information used by the dedicated pharmacist 1052 or customer 1051, may be from a reference object that contains expected sensor or characteristic values for the sample product.

The described system and method may provide various benefits over traditional pharmacy processing systems. First, the distributed processing system and method may enable distribution of order work tasks to a plurality of geographically separated entities, including pharmacy resources and customers. Second, the system and method may provide more convenient point of sales locations to a customer by using patient access terminals that are much easier to distribute near a customer. In one embodiment, the added convenience may justify shifting part of the burden of information processing upon the customer (e.g., verification). Also, the system and method may further ensure the accurate vending of a drug product of the customer's prescription order by enabling remote verification of a physical product order.

What is claimed:

1. A method of managing prescription orders within a network of pharmacy resources connected by an information processing system, the method comprising:
capturing at a first patient access terminal an image associated with a pharmacy prescription order and creating an image object containing the image at the first patient access terminal;
creating a task object that is associated with the image object, wherein the task object stores information associated with the image object and the prescription order;
routing at least one of the image object or the task object to a first computer associated with a first pharmacy resource; and
verifying that data contained in the task object corresponds to prescription information represented by the image contained in the image object.

2. The method of claim 1, wherein the image object comprises at least one of an image of a physical prescription order, a certificate of medical necessity (CMN) form, a laboratory datasheet, a customer photo identification, a medical insurance card, a check, a money order, or a credit card.

3. The method of claim 1, wherein verifying the data contained in the task object is performed by one of a user at the patient access terminal or a first pharmacy resource associated with the first computer.

4. The method of claim 3, further comprising displaying at the patient access terminal whether the data contained in the task object corresponds to prescription information represented by the image contained in the image object when the verifying is performed by a first pharmacy resource associated with the first computer.

5. The method of claim 1, further comprising modifying the task object by one of a user at the first patient access terminal or a first pharmacy resource associated with the first computer, to capture information contained in the image object.

6. The method of claim 5, wherein modifying the task object comprises using a text recognition program to perform a translation of data stored in the image object into electronic text data captured by the task object and displaying at the patient access terminal the electronic text data.

7. The method of claim 6, wherein verifying comprises one of using the patient access terminal to compare the image object data and electronic text data to determine an inconsistency or prompting a user at the patient access terminal to input a confirmation that at least a portion of the electronic text data corresponds to at least a portion of the prescription order image.

8. The method of claim 1, further comprising displaying on the patient access terminal a list of pharmacy delivery options based on at least one of pharmacy resource workload, a pharmacy resource capacity, proximity to a pharmacy resource, or a customer pickup preference and wherein routing at least one of the image object and task object to a first computer is based on a customer selected delivery option.

9. The method of claim 1, further comprising creating a sensor data object containing a sensor reading of a sample of a drug product associated with the prescription order and storing in a database a pharmacy product reference object that contains information on a characteristic of a pharmacy product and indexed by a product identifier.

10. The method of claim 9, further comprising retrieving at a second computer, the image object, the task object, the sensor data object, and the pharmacy product reference object, and determining whether data of the sensor data object and task object correspond to data in the product reference object.

11. A patient access terminal comprising:
a display unit that is capable of generating video images;
a first input device;
a second input device;
a processing apparatus operatively coupled to said display unit and said input device, said processing apparatus comprising a processor and a memory operatively coupled to said processor;
a network interface connected to a network and to the processing apparatus;
said processing apparatus being programmed to:
prompt a user to enter customer information using the first input device and create a task object based on the data inputted by the user;
prompt the user to use the second input device to scan a physical item associated with a prescription order and create an image object based on data from the scan;
route at least one of the image object and task object to a first computer based on a criteria.

12. The patient access terminal of claim 11, wherein the processing apparatus is further programmed to translate a portion of the image object into electronic text data, and wherein prompting a user to enter customer information using the first input device comprises prompting the user to verify that the electronic text data is correct.

13. The patient access terminal of claim 11, wherein the processing apparatus is further programmed to translate a portion of the image object into electronic text data and to compare portions of the translated image data to determine an inconsistency.

14. The patient access terminal of claim 11, further comprising a printer and wherein the processing apparatus is further programmed to use the printer to print an order confirmation document containing a prescription identifier.

15. The patient access terminal of claim 11, further comprising a printer and wherein the processing apparatus is further programmed to use the printer to print a customer specific report.

16. The system of claim 11, wherein the criteria comprises at least one of a pharmacy resource workload, a pharmacy resource capacity, a proximity to a pharmacy resource, or a customer pickup preference.

17. A pharmacy network system comprising:
a first patient access terminal coupled to a network and adapted to create an image object of a prescription order and a task object that stores information associated with the image object, wherein the first patient access terminal is adapted to route at least one of the image object and the task object over a network;
a first computer coupled to the network and adapted to create a sensor data object based on a first sensor reading of a sample of a product associated with the prescription order;
a second computer coupled to the network and adapted to receive the image object, the task object, and the sensor data object over the network,
wherein the second computer is further adapted to retrieve a product reference object corresponding to a characteristic of the prescription product based on a product identifier represented in the image object of the prescription order, and determine whether data of the first sensor data object corresponds to the product reference object.

18. The system of claim 17, wherein the image object contains an image of at least one of a certificate of medical necessity (CMN) form, a laboratory datasheet, a customer photo identification, a medical insurance card, a check, a money order, or a credit card.

19. The system of claim 17, wherein the first computer is further adapted to initiate the release of a filled prescription to a customer at a pharmacy resource of the first computer based on authentication of a confirmation document printed at the first patient access terminal and an indication from the second computer that data of the first sensor data object corresponds to the product reference object.

20. The system of claim 17, further comprising a second patient access terminal adapted to receive a prescription identifier of the prescription order and display a portion of data from at least one of the task object or image object.

21. The system of claim 17, wherein the sensor reading comprises at least one of weight data, spectrographic data, olfaction data, pH data, toughness data, tensile strength data, composition data, temperature data, humidity data, or image data.
